(19) United States
(12) Patent Application Publication
(10) Pub. No.: US 2019/0367169 A1
(43) Pub. Date: Dec. 5, 2019

(54) UNMANNED FLYING GRENADE LAUNCHER

(71) Applicant: Bryan Patrick O'Leary, Belgrade, MT (US)

(72) Inventor: Bryan Patrick O'Leary, Belgrade, MT (US)

(21) Appl. No.: 16/424,029

(22) Filed: May 28, 2019

Related U.S. Application Data
(60) Provisional application No. 62/676,532, filed on May 25, 2018.

(51) Int. Cl. B64D 7/06; F41F 1/00; F41G 3/22; B64C 39/02; B64C 27/00

(52) U.S. Cl. CPC B64D 7/06; F41F 1/00; F41G 3/22; B64C 2201/121; B64C 27/00; B64C 2201/027; B64C 39/024

(57) ABSTRACT

An unmanned flying grenade launcher system is provided. The unmanned flying grenade launcher can include a portable unmanned aerial vehicle with an attachment apparatus configured to receive a standardized grenade launcher, and a servo coupled to adjust the angle of the grenade launcher relative to the portable unmanned aerial vehicle downward relative to the unmanned aerial vehicle. One or more telemetry systems can provide a visual indication of the unmanned aerial vehicle's surroundings to an operator, and can receive flight commands and firing commands from the operator such that a firing mechanism fires the standardized grenade launcher in response to the firing command.

### CROSS-REFERENCE TO RELATED APPLICATIONS

This Application claims priority to U.S. Provisional Patent Application Ser. No. 62/276,532, filed on May 25, 2018, to Bryan Patrick O'Leary, entitled “Unmanned Flying Grenade Launcher,” currently pending, the entire disclosure of which is incorporated herein by reference.

### FIELD OF THE INVENTION

The invention relates generally to defense systems, and more specifically to an unmanned aerial vehicle with a grenade launcher.

### BACKGROUND OF THE INVENTION

National defense and law enforcement personnel have long desired weapons that give them an advantage over opponents or threats, such as more accurate or more lethal weapons and weapons that subject the user to less risk while in combat. Further, it is desirable that any such weapons system be sufficiently cost-effective and portable to be usable in combat, and work in a wide variety of environments.

For example, the Predator remotely-piloted aircraft that became famous for its role in conflicts in Afghanistan and the Middle East costs about four million dollars per vehicle, while a typical military fighter aircraft costs many tens of millions of dollars each and puts a pilot's life at risk each time it flies into combat. While originally designed to provide battlefield surveillance, the Predator drone has been adapted to fire laser-guided air-to-ground Hellfire missiles, and to perform other functions more typical of a combat aircraft. The Predator's successor, the Reaper, can fly about three times as fast as a Predator, can carry twice the number of Hellfire missiles, and can carry up to 15 times the payload weight of its predecessor. Additional munitions are also supported, including Paveway II laser-guided bombs, Hellfire II air-to-ground missiles, the Sidewinder air-to-air missile, and JDAM guided bombs.

But, this added capability comes with a significant cost, with the Reaper expected to cost approximately $17 million per unmanned aircraft. While such an unmanned aerial vehicle (UAV) may help to displace more expensive manned aircraft in many typical combat situations, it remains too expensive for routine use by homeland security, law enforcement, or ground troops in combat situations. At 36 feet long with a wingspan of over 65 feet and a weight of nearly 5,000 pounds, the Reaper is further not easily carried into battle or with patrolling homeland security or other law enforcement. Instead, operations are usually planned in advance as coordinated efforts, with vehicles such as the Predator and Reaper piloted remotely by pilots who follow training and combat procedures much like those used in conjunction with typical piloted military aircraft.

Such weapons are therefore rarely used against a single insurgent or small group of enemies, or against targets having low value such as suspected improvised explosive devices (IEDs) or hiding places used by enemy combatants. The unit cost per weapon is too high to make them available for every such instance in a typical combat zone, and the cost is prohibitive for most all domestic law enforcement operations. A need therefore exists for a more cost-effective system and method of attacking small targets such as these while limiting risk to military or law enforcement personnel.

### BRIEF SUMMARY OF THE INVENTION

The present invention is directed generally to an unmanned flying grenade launcher system. One example embodiment of the invention comprises a portable unmanned aerial vehicle, including an attachment apparatus configured to receive a standardized grenade launcher, and a servo coupled to adjust the angle of the grenade launcher relative to the portable unmanned aerial vehicle downward relative to the unmanned aerial vehicle. According to one embodiment, one or more telemetry systems are included and can provide a visual indication of the unmanned aerial vehicle's surroundings to an operator, and can receive flight commands and firing commands from the operator such that a firing mechanism fires the standardized grenade launcher in response to the firing command.

According to one embodiment, the configuration for attachment to a standard military rifle comprises a Weaver accessory rail, a Picatinny accessory rail, or a Heckler & Koch grenade launcher adapter.

According to one embodiment, the servo is further operable to servo coupled to adjust the angle of the grenade launcher relative to the portable unmanned aerial vehicle in at least the downward angle from zero degrees level to ninety degrees straight down, thereby enabling it to fire a grenade to shoot horizontally into windows or doors or attack targets vertically from above.

The details of one or more examples of the invention are set forth in the accompanying drawings and the description below. Other features and advantages will be apparent from the description and drawings, and from the claims.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a top view of an unmanned aerial vehicle with an attached standard grenade launcher in accordance with one embodiment of the present invention;

FIG. 2 is a side view of an unmanned aerial vehicle with an attached standard grenade launcher in accordance with one embodiment of the present invention;

FIG. 3 is a front view of an unmanned aerial vehicle with an attached standard grenade launcher in accordance with one embodiment of the present invention;

FIG. 4 is a top view of a folded unmanned aerial vehicle with an attached standard grenade launcher in accordance with one embodiment of the present invention;

FIG. 5 is a side view of a folded unmanned aerial vehicle with an attached standard grenade launcher in accordance with one embodiment of the present invention; and

FIG. 6 is a flowchart of a method of operating an unmanned aerial vehicle with a grenade launcher in accordance with one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

Unmanned Aerial Vehicles (UAVs) used in combat, such as the Predator and Reaper drones, are too expensive to use for small threats, and require pilots with training and experience similar to that of manned combat aircraft to operate. Their size and weight limits the ability to transport them, and a typical ground combat platoon or company would therefore be unlikely to have their own such weapon or have such a weapon available to support them for all but the most significant combat threats.

In a typical combat environment, ground troops rely on traditional technology such as machine guns, grenade launchers, mortars, and rocket launchers to combat enemies. These weapons are generally portable, easily carried by men or in a light vehicle, and are sufficiently easy to operate that most ground combat troops are capable of using them effectively without extensive training. But, these weapons systems typically require a soldier to be able to see the enemy, or get relatively close to the enemy to engage them, and so put the soldier at significant risk during combat.

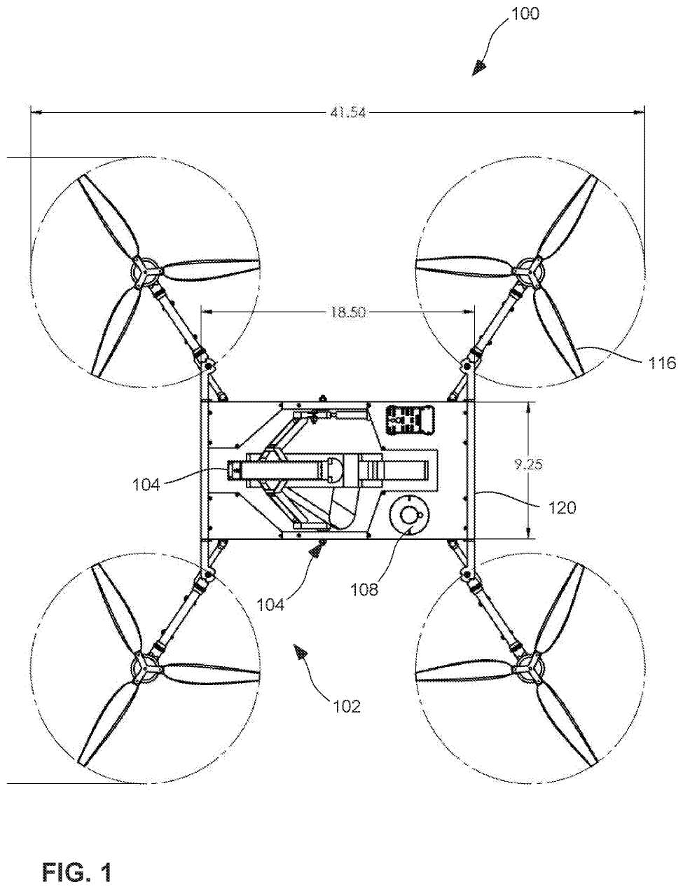

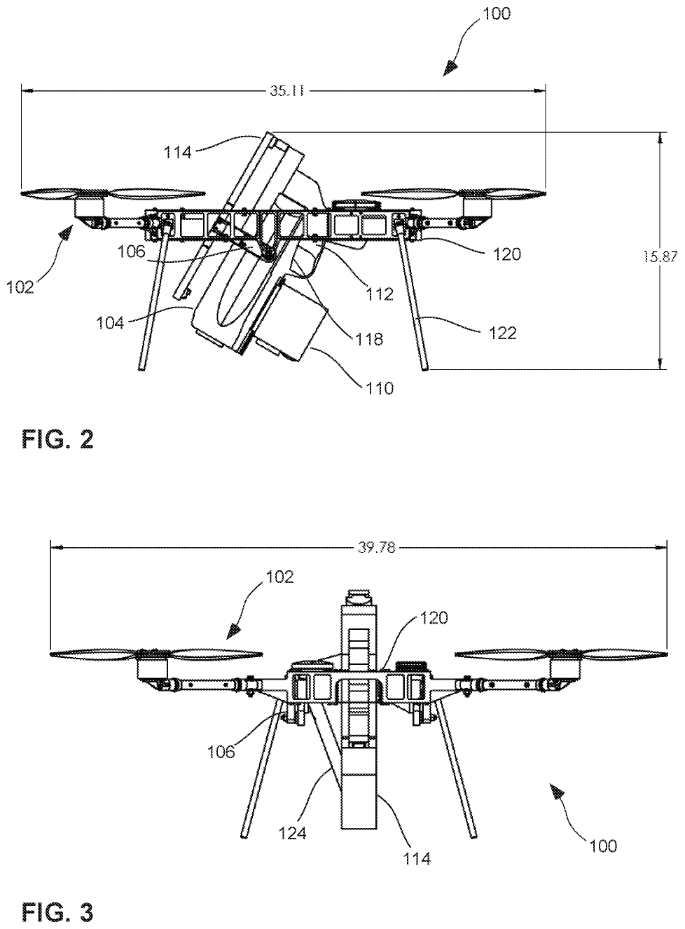

Referring to the figures, the present invention is directed toward an unmanned flying grenade launcher 100 that can include an unmanned aerial vehicle 102 and a standardized grenade launcher 104. The unmanned flying grenade launcher 100 and unmanned aerial vehicle 102 thereof, as shown in the various embodiments of the figures and described herein, can provide many of the advantages of an unmanned aerial vehicle such as a Predator drone system, at a cost, weight, and complexity that makes them suitable for widespread use by ground troops or law enforcement personnel. According to one embodiment as best shown in FIG. 1, the unmanned aerial vehicle 102 may include an attachment apparatus 106 configured to receive the standardized grenade launcher 104, and a servo 108 coupled to adjust the angle of the grenade launcher 104 relative to the portable unmanned aerial vehicle 102. Depending on the particular embodiment, the servo 108 may be configured to adjust the grenade launcher 104 vertically relative to the unmanned aerial vehicle 102 or horizontally relative to the unmanned aerial vehicle 102, or both. As best shown in FIG. 2, the unmanned flying grenade launcher 100 may also include one or more telemetry systems 110 that can provide a visual indication of the surroundings of the unmanned flying grenade launcher 100 to an operator, and/or can receive flight commands and firing commands from the operator such that a firing mechanism 112 fires the standardized grenade launcher in response to the firing command.

This configuration can enable the unmanned flying grenade launcher 100 to effectively target enemy positions that are hidden, such as behind a wall, within a window, or over a hill from the vehicle operator's position. In combat, enemies frequently take cover in buildings or behind walls where their location and movement is difficult to track. Returning fire on such enemies can be particularly difficult using traditional ground troop weapons, as the enemy's location is uncertain and a soldier exposing himself to have a clear view of the enemy's position leaves the soldier vulnerable to attack such as from snipers. Also, armed conflicts often involve overcoming enemies entrenched in bunkers, concealed in thick vegetation, or hidden in trenches that present a significant risk to attacking troops using direct-fire weapons such as rifles.

Similarly, according to various embodiments of the present invention, the unmanned flying grenade launcher 100 can be used in a domestic law enforcement environment, such as against a mass shooter or sniper who has taken cover in a building or other concealed location, or against a terrorist threat where exposing a law enforcement officer to return direct fire such as with a rifle would expose the officer to significant danger while being relatively ineffective against the threat.

According to certain embodiments, the unmanned flying grenade launcher 100 may be operable to use telemetry such as optical, infrared, laser, radar, Global Positioning System (GPS), and/or other such sensors to maneuver around an obstacle and have a clear view of the target. According to additional embodiments, one or more other systems or components, such as another unmanned aerial vehicle may provide target location, visual information, and/or other information to the unmanned flying grenade launcher 100. In a further embodiment, one or more of the systems, such as an optical camera or laser indicator, may be mounted substantially parallel to the grenade launcher mount and the grenade launcher 104, thereby providing an effective remote means of aiming and targeting the grenade launcher 104 aboard the unmanned flying grenade launcher 100.

Standard grenade launcher 104 may be configured as any suitable grenade launcher, such as a 40 mm M203 grenade launcher commonly issued for use with service rifles or the newer M320 often used as a standalone grenade launcher or attached to a rifle, and may enable repurposing equipment already commonly and widely available in the military to be used with the unmanned flying grenade launcher 100. As shown in FIGS. 2 and 3, according to certain embodiments, grenade launcher 104 may be attached to the unmanned aerial vehicle 102 by mounting an available standard grenade launcher 104 to a rail system 114 such as a Picatinny or Weaver rail on the unmanned aerial vehicle 102, In a further example, other standardized grenade launcher systems may be used, such as a Heckler & Koch grenade launcher adapter used with the AG36 grenade launcher. Any other suitable means may also be used for mounting and/or attaching grenade launcher 104 to unmanned flying grenade launcher 100.

Use of a standardized grenade launcher 104 may also enable use of a wide variety of existing compatible munitions, such as flares, smoke grenades, flash-bang grenades, tear gas grenades, and traditional antipersonnel grenades. These grenades range from those designed to subdue or stun a target, to less-than-lethal and lethal grenades designed to incapacitate or kill targets. Grenades such as these have the further advantage of operating using a high-low pressure system, where a relatively small high-pressure chamber stores propellant for a grenade cartridge, which when ignited bleeds out through vents or ports to a much larger low pressure chamber to propel the grenade or other projectile forward. This enables a relatively large projectile to be launched without the heavy barrel, chamber, or other equipment typically associated with large-diameter munitions. It also enables the grenade launcher 104 to have greatly reduced or negligible recoil, thereby making it suitable for use if unmanned aerial vehicle 104 is configured as a relatively small unmanned aerial vehicle without knocking the vehicle 104 significantly off its flight path or damaging or destroying the vehicle 104.

As best shown in FIG. 1, unmanned aerial vehicle 102 may be configured as a quad copter having four separate blades or propellers 116 spinning in a plane (or in multiple planes) relatively parallel to the ground enables both fast and slow movement as well as hovering to discover and engage a potential threat. Such vehicles 102 are also able to fly low to the ground and can move in unpredictable ways to evade enemy fire, and are relatively low cost to replace if damaged or destroyed while in operation. Further, many such unmanned aerial vehicles 102 are small enough and quiet enough to be concealed among their surroundings, such as hiding behind a tree or hovering in a building without being easily detected in a combat zone. While the embodiments illustrated in the several figures show the unmanned aerial vehicle 102 configured as quadcopter mounted configuration, it is further recognized that any suitable configuration may be utilized in connection with the present invention. For example, the unmanned grenade launcher 100 of the present invention may incorporate an unmanned aerial vehicle 102 configured with a traditional helicopter configuration (i.e., main and tail rotor), a coaxial helicopter configuration, a tandem helicopter configuration, tilt rotor or tilt wing configuration, any suitable multi-rotor configuration (e.g., quad, hex, double quad, octocopter, etc.) or any other suitable configuration now known or hereinafter developed.

Once the unmanned aerial vehicle 102 and unmanned flying grenade launcher 100 has found an enemy or other target, an operator or pilot can aim the grenade launcher 104 such a by turning the unmanned flying grenade launcher 100 horizontally toward the target and vertically positioning the grenade launcher 104 to fire in the intended direction. In some environments such as firing through a window or door this may be substantially horizontal, while in other environments such as behind a wall the angle of fire may be relatively vertical. Vertically positioning the grenade launcher 104 in a more detailed example can include orienting the grenade launcher 104 anywhere from flat horizontal with the platform or deck 118 of the unmanned aerial vehicle 102 (and typically the ground) to 90 degrees vertical from that position, pointing down.

The fired projectile in various examples may be a flash-bang, smoke grenade, or tear gas grenade designed to subdue an enemy or other target so that military or law enforcement can more safely move in to capture the target, and in other examples is a less-than-lethal or lethal grenade such as a buckshot grenade designed to clear a room or other space of enemy combatants.

The unmanned flying grenade launcher 100 with the unmanned aerial vehicle 102 configured to mount and fire a grenade launcher 104 can provide may significant advantages. One significant advantage is that the unmanned flying grenade launder 100 is portable, as a typical grenade launcher such as the M203 or M320 weighs only about three pounds. The unmanned aerial vehicle 102 (which may be configured as a quad copter drone according to one embodiment) may be configured to lift and fire the grenade launcher 104, and therefore need not weigh the thousands of pounds that existing military drones do. The entire system 100 comprising an unmanned aerial vehicle 102, a grenade launcher 106, grenade rounds to be fired, and unmanned aerial vehicle controls can likely be carried by a single person. Because there is no need for specialized or heavy equipment to move such a system 100 with troops while moving through an area of battle, the unmanned aerial vehicle grenade launcher system 100 is easy to carry to the front lines of battle, and relatively likely to be available to troops when needed.

According to certain embodiments, the cost of such the unmanned drone system 100 is not in the millions or tens of millions of dollars as with existing military unmanned aerial vehicle platforms, but is in the thousands to tens of thousands of dollars, consistent with other weapons commonly issued to individual soldiers, squads, or platoons. Replacement parts are relatively very affordable and the unmanned aerial vehicle 102 is easily field-serviceable without special tools by untrained personnel, making the system relatively robust and reliable.

According to certain embodiments, trained pilots are not needed to operate the unmanned flying grenade launcher 100, which may be operated by a soldier or law enforcement officer with little or in some cases no formal training. Because a typical unmanned aerial vehicle 102, such as a quad copter can hover, is stable in flight, and provides visual feedback of position and orientation to the operator, it can be easily controlled with simple joystick controls similar to remote control toys familiar to many. In a further example, unmanned aerial vehicle 102, the firing of grenade launcher 104, or other operational steps may be automated, such as by use of laser target illumination Global Positioning Systems (GPS), artificial intelligence such as image recognition, and other such technologies that can be incorporated into one or more systems or components onto unmanned flying grenade launcher 100.

According to certain embodiments, telemetry system 110 may include an optical or infrared camera, laser rangefinder, laser designator, and/or other such device that can be mounted too the unmanned aerial vehicle 102. According to one embodiment, such telemetry system 100 may be configured to be parallel to the standard grenade launcher 104, such as on the same or a parallel rails system 114, and may be configured to provide the operator with visual verification of the aim point grenade launcher 104 while in operation. Use of a laser rangefinder, for example, may allow the operator to determine the distance from the unmanned aerial vehicle 102 to the target, thereby allowing the operator to target the grenade launcher 104 to account for the ballistic arc taken by the projectile to be fired, or enabling the unmanned aerial vehicle's 102 control system or other system element to calculate the ballistic trajectory. Because the trajectory is based on the weather conditions, the angle of fire relative to the ground, and the type of projectile being fired, automated calculation and visual indication of the expected trajectory is desirable. According to one embodiment, the unmanned flying grenade launcher system 100 is operable to laser designate the target by shining a laser beam on the target (or to sense the laser designation from another source) and to fire a projectile that can alter its path in flight to hit the point illuminated by the laser. This provides relatively precise targeting capability, such as where a terrorist or enemy combatant is concealed in a public location such as a populated city.

According to one embodiment, the unmanned flying grenade launcher system 100 may include a safety mechanism 118. According to certain embodiments, standard grenade launcher 104 attached to the unmanned aerial vehicle 102 may incorporate a manual safety 118 to prevent inadvertent fire, which can be turned off just before the unmanned aerial vehicle 102 becomes airborne to prevent inadvertent firing of the grenade launcher 104 while the unmanned aerial vehicle system 100 is being configured. In another embodiment, one or more electronic fire control safeties 118 may be incorporated, such as an electronically actuated safety or firing pin block that is actuated using the unmanned aerial vehicle's telemetry and control system 110 before firing the grenade launcher 104.

Turning now to FIG. 1, a top view of the unmanned flying grenade launcher system 100 in accordance with one embodiment is shown schematically. As shown, system 100 may include unmanned aerial vehicle 102 with an attached standard grenade launcher 104. As shown, the unmanned aerial vehicle 102 may include a frame or platform 120 that may comprise a power source such as a battery, electronics such as flight control and other telemetry systems 110, and an attachment apparatus or similar mount system 106 to which a standard grenade launcher 104 may be attached. The unmanned aerial vehicle 102 in this configuration is sometimes called a quad copter, as it has four independent propellers 116 configured to spin substantially parallel to the ground while in slow flight or hovering (however, it is recognized that any suitable configuration of vehicle 102 may be utilized in system 100). By independently varying the speed of the propellers 116, the altitude, tilt or attitude, speed, and other position parameters of the unmanned aerial vehicle 102 can be controlled, enabling relatively stable and controlled flight.

According to the embodiment shown in FIG. 1 (as well as FIGS. 2-5), the attachment apparatus/mounting system 106 may include a rail system 114 to which the grenade launcher 106 is mounted. As best shown in FIG. 2, the rail system 114 can tilt from being horizontal to the ground or the plane in which the propellers 116 are configured, to being 90 degrees down from that plane, including any angle in between horizontal and 90 degrees down. As further shown schematically in FIG. 1, according to one embodiment, system 100 may include a servo 108 configured to operate the rotation of grenade launcher 104 via mounting system 106 and/or rail system 114.

FIG. 2 schematically shows a side view of the unmanned flying grenade launcher system 100 in accordance with one embodiment. As shown, unmanned aerial vehicle 102 may include rail system 114 configured to receive grenade launcher 104, which is shown as being tilted down at approximately a 60 degree angle for merely exemplary purposes. The grenade launcher 104 is tilted in this example by use of the electronically-actuated servo 108 coupled to the rail system 114 and to the platform or chassis 120 of the unmanned aerial vehicle 102. As further shown in FIG. 2, according to one embodiment, telemetry system 110 may include an optical camera, which in alternate embodiments may be any another telemetry device or comprise multiple such devices. As further shown in FIG. 2, according to one embodiment, unmanned aerial vehicle 102 may include legs 122, which support the unmanned aerial vehicle before takeoff and during landing.

FIG. 3 schematically shows a front view of the unmanned flying grenade launcher system 100 in accordance with one embodiment. According to the embodiment shown in FIG. 3, an arm 124 is coupled to the rail 114 to which the grenade launcher 104 is mounted and to the chassis 120, enabling electronic control of the tilt angle of the grenade launcher 104 relative to the chassis 120 of the unmanned aerial vehicle 102.

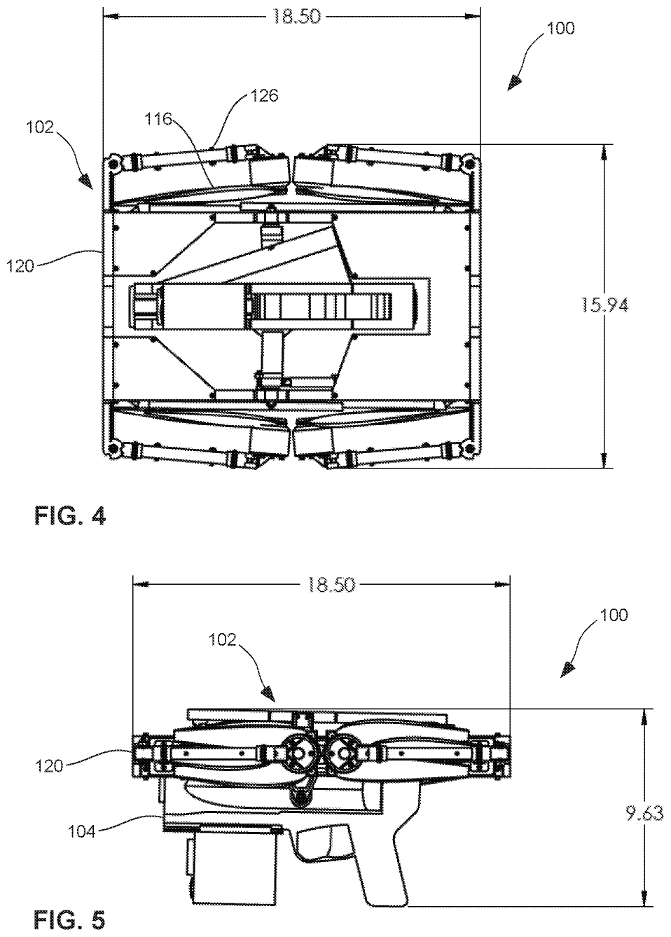

FIG. 4 schematically shows a top view of the unmanned flying grenade launcher system 100 where the unmanned aerial vehicle 102 is in a folded configuration, in accordance with one embodiment. As shown, the propeller support arms 126 are folded in toward the chassis 120 of the unmanned aerial vehicle 102, and the propellers 116 are folded in parallel to the propeller support arms 126.

FIG. 5 schematically shows a side view of the unmanned flying grenade launcher system 100 a folded configuration in accordance with one embodiment. as shown, the grenade launcher 104 remains mounted to the unmanned aerial vehicle's chassis 120, brought back to a horizontal angle relative to the chassis 120 for storage. In an alternate embodiment, the grenade launcher 104 may be removed from the chassis 120 before it is folded or otherwise folded, configured, or disassembled for storage or transport.

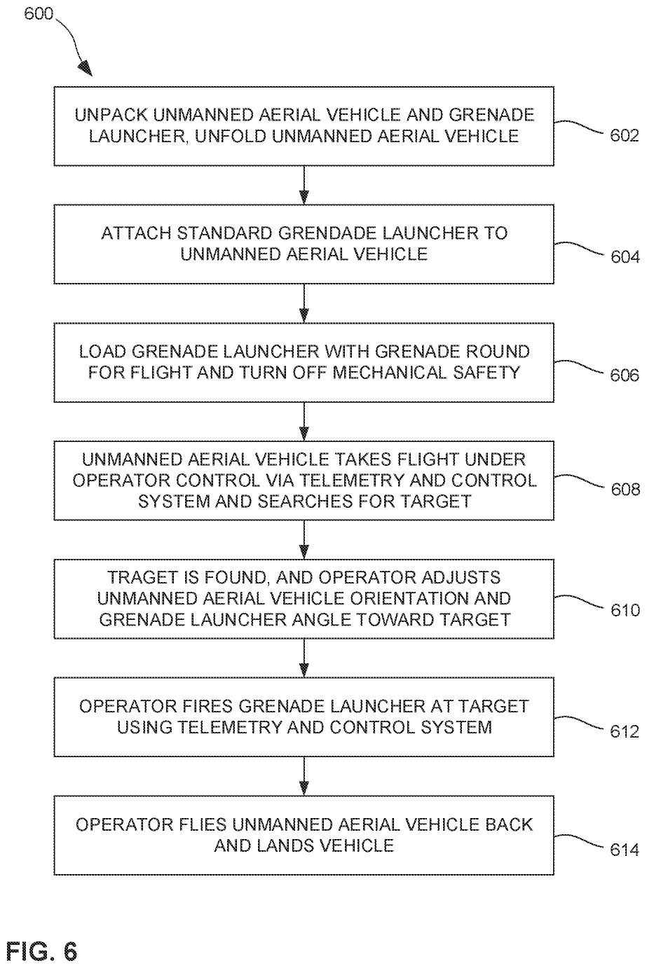

FIG. 6 provides a flowchart of a method 600 of operating unmanned flying grenade launcher system 100 in accordance with one embodiment. At 602, an unmanned aerial vehicle 102 and its accompanying remote control and telemetry system 110 may be removed from packaging, such as a carrying case, and unfolded. At 604, a standard grenade launcher 104 may be attached to an attachment apparatus 106 (such as rail system 114) that is coupled to the platform/chassis 120 of the unmanned aerial vehicle 102. At 606, the grenade launcher 104 may be loaded for flight, and the mechanical safety 118 may be turned off. At 608, the unmanned aerial vehicle 102 may take flight under the control of an operator using the remote control and telemetry system 110, which the operator may use to guide the unmanned aerial vehicle 102 toward a target.

At 610, a target is found, such as with a video camera comprising part of the unmanned aerial vehicle's telemetry system 110, and the operator configures the unmanned aerial vehicle orientation 102 and the accessory rail/grenade launcher angle to aim the grenade launcher 104 at the target. The operator may then fire the grenade launcher 104 at 612, and flies the unmanned aerial vehicle 102 back for landing at 614.

As described herein, the unmanned flying grenade launcher system 100 may include an unmanned aerial vehicle 102 configured to mount, transport, and fire a standard grenade launcher 104 and can thereby provide a portable, inexpensive, and easy to use alternative to traditional ground fighting weapons such as rifles and to more expensive options such as existing military drones. By using a standard rail system 106/114 to mount the grenade launcher 104, standard grenade launchers 104 already common in battle can be easily mounted to and controlled from the unmanned aerial vehicle 102. Additional sighting accessories such as a video camera or other telemetry devices 110 are easily mounted to the grenade launcher 104 and/or to the unmanned aerial vehicle's chassis 120, and the accessory rail 106/114 and grenade launcher 104 can be easily tilted from horizontal to 90 degrees down to aim the grenade launcher 104 at the target. The grenade launcher's mechanical safety 118 may be configured to prevent firing the grenade launcher 104 until it is manually disarmed just before takeoff, and in further examples electronic safety systems or fire control safeguards 118 may be configured to prevent inadvertent firing after the unmanned aerial vehicle 102 becomes airborne.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An unmanned flying grenade launcher, comprising:
a portable unmanned aerial vehicle;
an attachment apparatus coupled to the portable unmanned aerial vehicle and configured to receive a standardized grenade launcher;
a servo coupled to adjust the angle of the grenade launcher relative to the portable unmanned aerial vehicle in at least the downward angle relative to the unmanned aerial vehicle by adjusting an angle of the attachment apparatus relative to the unmanned aerial vehicle;
one or more telemetry systems operable to provide a visual indication of the unmanned aerial vehicle's surroundings to an operator and to receive flight commands and one or more firing commands from the operator; and
one or more firing mechanisms operable to fire the standardized grenade launcher in response to the firing command from the operator.

2. The unmanned flying grenade launcher of claim 1, wherein the one or more firing mechanisms comprises a solenoid configured to actuate a mechanical trigger on the standardized grenade launcher.

3. The unmanned flying grenade launcher of claim 1, wherein the one or more firing mechanisms comprises an electronically actuated firing pin.

4. The unmanned flying grenade launcher of claim 1, wherein the standardized grenade launcher comprises a grenade launcher configured for attachment to a standard military rifle.

5. The unmanned flying grenade launcher of claim 4, wherein the configuration for attachment to a standard military rifle comprises a Weaver accessory rail, a Picatinny accessory rail, or a Heckler & Koch grenade launcher adapter.

6. The unmanned flying grenade launcher of claim 1, wherein the servo is further operable to servo coupled to adjust the angle of the grenade launcher relative to the portable unmanned aerial vehicle in at least the downward angle from zero degrees level to ninety degrees straight down, thereby enabling it to fire a grenade to shoot horizontally into windows or doors or attack targets vertically from above.

7. The unmanned flying grenade launcher of claim 1, wherein the one or more telemetry systems operable to provide a visual indication of the unmanned aerial vehicle's surroundings comprises at least one electro-optical sensor, infrared sensor, or laser designator.

8. The unmanned flying grenade launcher of claim 1, wherein the one or more telemetry systems is mounted coincident with a barrel of the standardized grenade launcher.

9. The unmanned flying grenade launcher of claim 1, wherein a mechanical safety on the standardized grenade launcher is configured to be manually moved to a fire position before flight.

10. The unmanned flying grenade launcher of claim 1, further comprising an electronically actuated safety operable to be changed to a fire configuration while in flight.

11. The unmanned flying grenade launcher of claim 1, wherein the portable unmanned aerial vehicle comprises three or more propellers, each configured to spin in a circle substantially parallel to the ground when in still flight.

12. The unmanned flying grenade launcher of claim 11, wherein one or more of the three or more propellers is configured to unfold from the portable unmanned aerial vehicle to move from a compact stowed configuration to a flight configuration.

13. The unmanned flying grenade launcher of claim 1, wherein the one or more telemetry systems is further operable to provide at least one of position or guidance while in flight.

14. The unmanned flying grenade launcher of claim 13, wherein position comprises position derived via Global Positioning System (GPS).

15. The unmanned flying grenade launcher of claim 13, wherein guidance comprises guidance to a target.
